(19) United States
(12) Patent Application Publication
(10) Pub. No.: US 2014/0108829 A1
(43) Pub. Date: Apr. 17, 2014

(54) EXTERNAL STORAGE DEVICE AND DRIVING METHOD THEREOF

(71) Applicant: Chen Hsi TAI, New Taipei City (TW)

(72) Inventor: Chen Hsi TAI, New Taipei City (TW)

(21) Appl. No.: 13/740,338

(22) Filed: Jan. 14, 2013

(30) Foreign Application Priority Data
Oct. 17, 2012 (TW) 101138236

(51) Int. Cl. G06F 12/00; G06F 13/40; G06F 1/26

(52) U.S. Cl. CPC G06F 12/00; G06F 1/26; G06F 13/4068
USPC 713/300; 711/114; 710/313

(57) ABSTRACT

An external storage device comprises a plurality of hard disks, a control unit, a bridging unit, a connecting port and a voltage converter circuit. The control unit is coupled to the hard disks and ingrates the hard disks into a redundant array of inexpensive disks. The bridging unit is coupled to the control unit. The connecting port is coupled to the hard disks. The voltage converter circuit is coupled to the control unit and the bridging unit. The external storage device receives a power supplied from an electronic device through a transmission line. The power through the connecting port is transmitted directly to the hard disks in order to drive the hard disks. The voltage converter circuit converts the power and supplies the power to the control unit and the bridging unit. It is convenient for user to disconnect an extra power supply apparatus and a voltage transformer.

### BACKGROUND

1. Technical Field

The present disclosure relates to an external storage device and a driving method of the external storage device, in particular, to an external storage device with a plurality of hard disks and a driving method of the external storage device.

2. Description of Related Art

With the technology development, the computer multimedia flourishes rapidly. Therefore, the need of the data storage capacity for people is increasing day by day, and the need of external storage devices is increasing, too. For example, the external storage device can be a 500G or 1T portable hard drive, and can store more multimedia data.

In addition, although notebooks and desktops become universal, the originally equipped storage capacity of hard disks in these notebooks and desktops are small, or the hard disks are not portable, such the need of 2.5-inch external storage devices is getting popular for people. Moreover, since the volumes of 2.5-inch external storage devices are very small, the using probability of 2.5-inch external storage devices becomes larger.

However, a common external storage device always comprises a transformer. After the common external storage device connects the electronic device a through transmission line, the electronic device transmits a power to the common external storage device. Due to the insufficient provided current from the electronic device, the common external storage device is not able to be driven. Therefore, a designer of a common external storage device always interdicts the power provided from the electronic device in the common external storage device, and the designer takes a transformer as the main power source to provide a 5 volts/2 amps or a 12 volts/2 amps power to the external storage device. In addition, the transformer still needs to supply a power for the control chip, such that the power from the transformer needs to be reduced to a lower voltage through a buck converter circuit. Therefore, the circuit design of the common external storage drive is very complex, and the common external storage device consumes more power. As a result, it causes the large loss of power virtually.

Therefore, how to effectively provide the required power to the external storage device and simply the design of the drive circuit is an important issue at the present day.

### SUMMARY

An exemplary embodiment of the present disclosure provides an external storage device and a driving method of the external storage device to solve the above-mentioned problems.

The present invention provides an external storage device, and the external storage device comprises a plurality of hard disks, a control unit, a bridging unit, a connecting port and a voltage converter circuit. The control unit is electrically coupled to the hard disks for integrating the hard disks into a plurality of redundant array of inexpensive disks (RAID's). The bridging unit is coupled to the control unit for converting a Universal Serial Bus (USB) signal into a Serial Advanced Technology Attachment (SATA) signal. The connecting port is coupled to the hard disks. The voltage converter circuit is coupled to the control unit and the bridging unit. The external storage device receives a power provided from an electronic device through a transmission line, and the power is directly transmitted to the hard disks through the connecting port to drive the hard disks. The voltage converter circuit converts a power with a higher voltage to a power with a lower voltage and supplies the power with a lower voltage to the control unit and the bridging unit.

According to an exemplary embodiment of the present disclosure, the above-mentioned transmission line is a Y-shaped transmission line comprises a first connection interface, a second connection interface and a third connection interface. The first connection interface is electrically coupled to the connecting port. The second connection interface and the third connection interface are electrically coupled to the output-connecting port of the electronic device. A specification of the connecting port is USB 3.0 or USB 2.0, a specification of the second connection interface is USB 3.0, and a specification of the third connection interface is USB 3.0 or USB 2.0.

According to an exemplary embodiment of the present disclosure, the above-mentioned voltage converter circuit converts a power into a first voltage, a second voltage and a third voltage. The voltage converter circuit provides the first voltage and the second voltage to the control unit, and provides the first voltage and the third voltage to the bridging unit.

According to an exemplary embodiment of the present disclosure, the above-mentioned voltage converter circuit comprises a first converter element, a second converter element and a third converter element, the first converter element is electrically coupled between the second converter element and the third converter element.

According to an exemplary embodiment of the present disclosure, the above-mentioned first converter element is a pulse wave modulator or a low-dropout regulator, the above-mentioned second converter element is a pulse wave modulator or a low-dropout regulator, and the third converter element is a pulse wave modulator or a low-dropout regulator.

According to an exemplary embodiment of the present disclosure, the above-mentioned voltage converter circuit comprises a fourth converter element and a fifth converter element. The fourth converter element is electrically coupled to the fifth converter element.

According to an exemplary embodiment of the present disclosure, the above-mentioned fourth converter element is a dual-output-port pulse wave modulator, and the fifth converter element is a low-dropout regulator. A port of the fourth converter element is coupled to the fifth converter element.

According to an exemplary embodiment of the present disclosure, the above-mentioned fourth converter element is a low-dropout regulator, and the fifth converter element is a dual-output-port pulse wave modulator. The fourth converter element is electrically coupled to an input-port of the fifth converter element.

According to an exemplary embodiment of the present disclosure, the above-mentioned bridging unit is used for converting the USB signal into the SATA signal, and transmits the SATA signal to the control unit. The control unit comprises a RAID controller for integrating a plurality of hard disks into the RAID's. The RAID controller divides the RAID's into different storage modes to provide better transmission efficiency and to achieve data backup function, wherein each of the hard disks is a 2.5-inch hard disk.

The present invention provides a driving method of an external storage device, and the driving method comprises steps of: providing a transmission line couple between an external storage device and an electronic device; determining whether a connecting port of the external storage device receives a power supplying by the electronic device; if the connecting port of the external storage device receives the power supplied from the electronic device, the power is transmitted directly to the hard disks through the connecting port; and by using a voltage converter circuit of the external storage device, converting the power and supplying the power to the control unit and the bridging unit.

To sum up, the present disclosure is characteristic in, the power provided from an electronic device is directly supplied for the hard disks, and the power through the voltage converter circuit is converted into suitable voltages to meet the voltage requirements of the control unit and the bridging unit, such that the control unit can control the data access of the hard disks. By the above-mentioned mechanisms, the design of the driving circuit of the external storage device can be simplified. Moreover, the energy usage and the energy-saving efficiency can also be promoted.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 is a function block diagram of an external storage device according to an exemplary embodiment of the present disclosure;

FIG. 2 is a function block diagram of an external storage device according to another exemplary embodiment of the present disclosure;

FIG. 3 is a function block diagram of an external storage device according to another exemplary embodiment of the present disclosure;

FIG. 4 is a function block diagram of an external storage device according to another exemplary embodiment of the present disclosure; and

FIG. 5 is a flow chart of a driving method of an external storage device according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### First Exemplary Embodiment

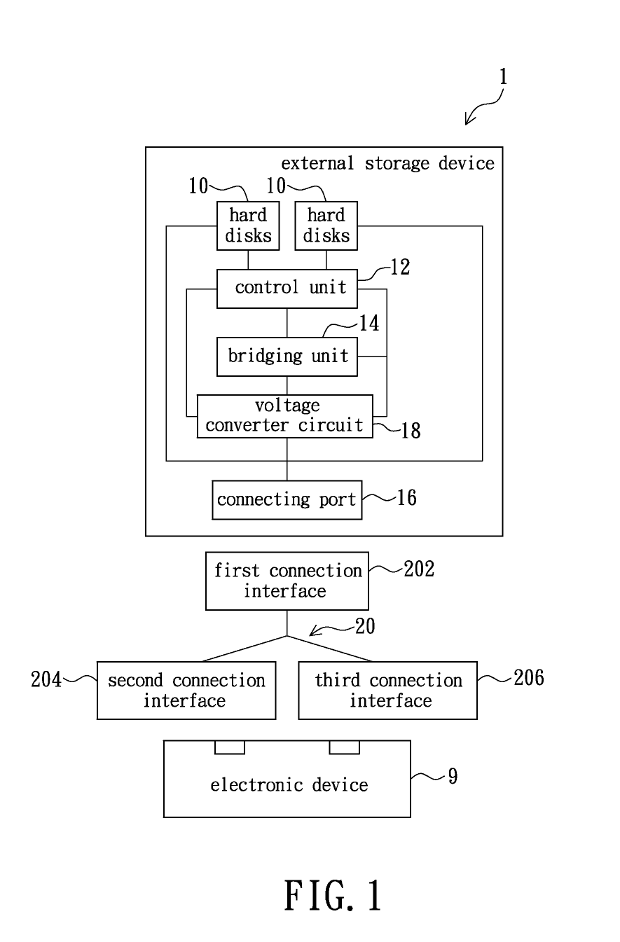

Please refer to FIG. 1. FIG. 1 is a function block diagram of an external storage device according to an exemplary embodiment of the present disclosure. An external storage device 1 comprises a plurality of hard disks 10, a control unit 12, a bridging unit 14, a connecting port 16, a voltage converter circuit 18 and a transmission line 20. In practice, the external storage device 1 is coupled to the electronic device 9 through the transmission line 20, and the electronic device 9 such as a computer, notebook or a tablet PC. So, the electronic device 9 can control data access and data backup operations in the external storage device 1.

The transmission line 20 such as a Y-shaped transmission line, comprising a first connection interface 202, a second connection interface 204 and a third connection interface 206. The first connection interface 202 is coupled to the connecting port 16. The second connection interface 204 and the third connection interface 206 are coupled to the output-connecting port 16 of the electronic device 9. The second connection interface 204 is USB 3.0, and the third connection interface 206 is USB 3.0 or USB 2.0. In another exemplary embodiment, the transmission line 20 such as a single cable transmission line. For example, the second connection interface 204 and the third connection interface 206 may disposed in the identical connector. The said identical connector is coupled to a single output-connecting port of the electronic device 9. Thus, the said identical connector may provide a current (more than 1400 mA), to drive the operation of the external storage device 1. Furthermore the said single cable transmission line may comprise a first connection interface 202 and a second connection interface 204. The first connection interface 202 is electrically coupled to the connecting port 16, and a specification of the first connection interface 202 is USB 3.0. The second connection interface 204 is electrically coupled to an output-connecting port of electronic devices 9, and a specification of the second connection interface 204 is USB 3.0. The exemplary embodiment of the present disclosure doesn't limit the Y-shaped transmission line 20 types of the first connection interface 202, the second connection interface 204 and the third connection interface 206.

In detail, the specification of USB 3.0 can provide a 900 mA current, and the specification of USB 2.0 can provide a 500 mA current. Therefore, the second connection interface 204 and the third connection interface 206 can provide a current (more than 1400 mA), and the 1400 mA current is enough to drive the operation of the external storage device 1.

The external storage device 1 doesn't use complex circuit design of a transformer to reduce the loss of energy. According to the power provided from the electronic device 9, the driving circuit of the external storage device 1 can be simplified to realize data access operations in the external storage device 1.

An exemplary embodiment of the present disclosure provides a plurality of hard disks 10, such as a 2.5-inch SATA hard disk, and the number of the hard disks 10 is two. The exemplary embodiment of the present disclosure does not limit the number of the hard disks 10. In practice, the SATA hard disk can be a hard disk conforms to SATA I (1.5 GB/s), SATA II (3.0 GB/s), or SATA III (6.0 GB/s) which is already mentioned in the above-specifications. A SATA hard disk has physical memory blocks to storage data, and then the hard disks 10 can be used for data access and data backup.

The control unit 12 is coupled between the hard disks 10 and the bridging unit 14 for arranging the hard disks 10 into a plurality of redundant arrays of independent disks, and the control unit 12 such as a Silicon Image 5923 chip. The exemplary embodiment of the present disclosure doesn't limit the type of the control unit 12. The control unit 12 receives the SATA signal transmitted from the bridging unit 14 to control the hard disks 10 operate data access and data backup.

In addition, the control unit 12 uses Redundant Array of Independent Disks (RAID) technology to integrate a plurality of small-capacity hard disks into an extendable logical drive, wherein the logical drive can be divided into a plurality of redundant arrays of independent disks. When the control unit 12 saves data, the data is divided into a plurality of data blocks, and then the data blocks are dividedly stored in the hard drives. Because the operation of data access can be done simultaneously, RAID technology can provide a better efficiency for data access. In order to avoid the loss of data caused by the damage of a hard disk, RAID technology uses the concept of parity check to assist the reconstruction of necessary data.

The bridging unit 14 is coupled between the control unit 12 and the connecting port 16 for converting the USB signal into SATA signal, and provides SATA signal to the control unit 12. The bridging unit 14 such as an ASmedia 1051 chip conforms to SATA I (1.5 GB/s), SATA II (3.0 GB/s), or SATA III (6.0 GB/s) which is already mentioned in the above-specifications. The exemplary embodiment of the present disclosure doesn't limit the type of the bridging unit 14. Of course, the bridging unit 14 can integrate a voltage regulator used for regulating 3.3V to 1.2V. For example, the bridging unit 14 can integrate a 1.2V voltage regulator, so the voltage converter circuit 18 can provide 3.3V voltage directly to the bridging unit 14, and then the 3.3V voltage can be regulated into a 1.2V voltage through the 1.2V voltage regulator in the bridging unit 14. Therefore, the complexity of the circuit design of the voltage converter circuit 18 can be simplified.

The connecting port 16 is coupled between the hard disks 10 and the transmission line 20 for receiving a power supplied from the electronic device 9, and then provides the power directly to the hard disks 10. In practice, the connecting port 16 such as a USB 2.0 or USB 3.0 whereby the electronic device 9 can provide a USB signal to the bridging unit 14 and provide a power to the hard disks 10 through the connecting port 16.

The voltage converter circuit 18 is coupled to the control unit 12, the bridging unit 14, and the connecting port 16. For example, the voltage converter circuit 18 is a combination of a pulse wave modulator and a low-dropout regulator. The voltage converter circuit 18 is used for providing a voltage to the control unit 12 and the bridging unit 14. For example, the voltage requirements of the control unit 12 are 3.3V and 1.8V, and the voltage requirements of the bridging unit 14 are 3.3V and 1.2V. By the voltage converter circuit 18, the 3.3V voltage is provided to the control unit 12 and the bridging unit 14, the 1.8V voltage is provided to the control unit 12, and the 1.2V voltage is provided to the bridging unit 14. The exemplary embodiment of the present disclosure doesn't limit the type of the voltage converter circuit 18.

In detail, the control unit 12 and the bridging unit 14 require two different voltages, respectively. When the external storage device 1 is coupled to the electronic device 9 through the transmission line 20, and the electronic device 9 detects the type of the external storage device 1 to recognize which communication protocol USB 2.0 or USB 3.0 is used by the external storage device 1. Both the control unit 12 and the bridging unit 14 are required to performed signal conversion to output SATA signal, therefore consumed more power. Based on the above-mentioned reasons, the control unit 12 and the bridging unit 14 are provided with two different voltages to have the external storage device 1 operate normally.

According to the above-mentioned reasons, the external storage device 1 of the present disclosure receives a power provided from the electronic device 9 through the transmission line 20, and then the power is transmitted and supplied directly to the hard disks 10 through the connecting port 16 to drive the hard disks 10. In addition, the voltage converter circuit 18 of the present disclosure converts voltages into suitable voltages to meet the voltage requirements of the control unit 12 and the bridging unit 14. In this way, the control unit 12 can provide SATA signal to control the hard disks 10 to operate data access and data backup. By the above-mentioned mechanisms, the driving circuit design of the external storage device 1 can be simplified, and the using of energy and the efficiency of energy-saving can also be promoted.

### Second Exemplary Embodiment

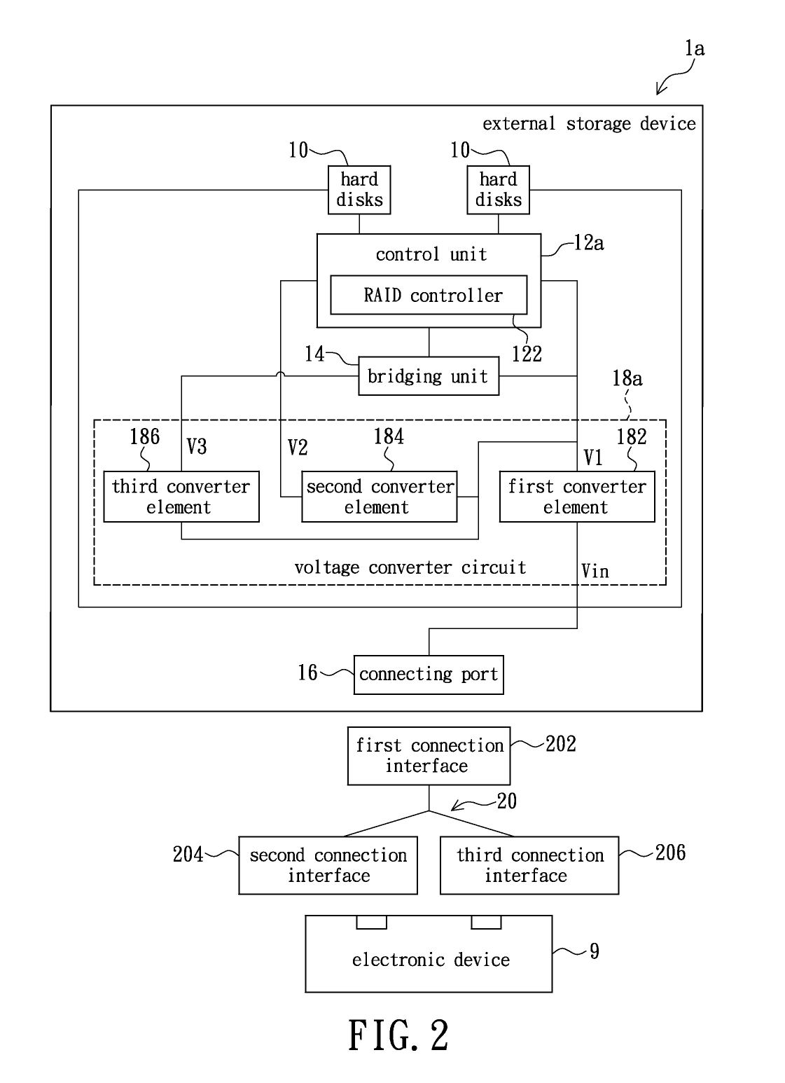

Please refer to FIG. 2. FIG. 2 is a function block diagram of an external storage device according to another exemplary embodiment of the present disclosure. The structures of the external storage device 1a (in FIG. 2) and the external storage device 1 (in FIG. 1) are similar to each other. The difference between the external storage device 1a and the external storage device 1 are that: the voltage converter circuit 18a comprises a first converter element 182, a second converter element 184, and a third converter element 186, wherein the first converter element 182 is coupled to the second converter element 184 and the third converter element 186; the second converter element 184 is coupled to the control unit 12a; the third converter element 186 is coupled to the bridging unit 14.

In practice, the first converter element 182 is a pulse wave modulator or a low-dropout regulator, the second converter element 184 is a pulse wave modulator or a low-dropout regulator, and the third converter element 186 is a pulse wave modulator or a low-dropout regulator. Therefore, the number of the combinations of the first converter element 182, the second converter element 184, and the third converter element 186 is eight. Each combination can provide voltages requiring by the control unit 12a and the bridging unit 14. The exemplary embodiment of the present disclosure merely proposes one embodiment to introduce the contents of the present disclosure. Those skilled in the art should be able to deduce the other embodiments about using a pulse wave modulator or a low-dropout regulator to change the combinations of the first converter element 182, the second converter element 184, and the third converter element 186 according to the disclosure of the present invention, and the description is omitted.

In addition, the converted power of the voltage converter circuit 18a is a first voltage V1, a second voltage V2, and a third voltage V3. The voltage converter circuit 18a provides a first voltage V1 and a second voltage V2 to the control unit 12a, and provides a first voltage V1 and the third voltage V3 to the bridging unit 14. The exemplary embodiment of the present disclosure doesn't limit the value of the first voltage V1, the second voltage V2, and the third voltage V3. Those skilled in the art should be able to deduce the other embodiments according to their actual demands.

For example, the first converter element 182 is a first pulse wave modulator, the second converter element 184 is a low-dropout regulator, and the third converter element 186 is a second pulse wave modulator. The first pulse wave modulator and the second pulse wave modulator have an input port and an output port respectively, and the low-dropout regulator also has an input port and an output port. The first pulse wave modulator is coupled to the low-dropout regulator and the second pulse wave modulator, the low-dropout regulator is coupled to the control unit 12a, and the second pulse wave modulator is coupled to the bridging unit 14.

In detail, the first converter element 182 is a pulse wave modulator to output the first voltage V1, and the first voltage V1 is supplied to the control unit 12a, the bridging unit 14, the second converter element 184, and the third converter element 186. The second converter element 184 receives the first voltage V1 and converts it into the second voltage V2, and provides the second voltage V2 to the control unit 12a. The third converter element 186 receives the first voltage V1 and converts it into the third voltage V3, and provides the third voltage V3 to the bridging unit 14.

For example, the connecting port 16 receives 5V voltage provided from the electronic device 9, and the 5V voltage is supplied to the hard disks 10 to drive the hard disks 10 operate normally. The first converter element 182 receives the power and converts it into the first voltage V1 (3.3 V), and the first voltage V1 is supplied to the control unit 12a, the bridging unit 14, the second converter element 184, and the third converter element 186. The second converter element 184 receives the first voltage V1 and converts it into the second voltage V2 (1.8 V), and the second voltage V2 is supplied to the control unit 12a. The third converter element 186 receives the first voltage V1 and converts it into the third voltage V3 (1.2 V), and the third voltage V3 is supplied to the bridging unit 14.

In particular, the control unit 12a comprises a RAID controller 122 used for transmitting the SATA signal to each of the hard disks 10, and then the hard disks 10 can be integrated into a plurality of redundant arrays of independent disks. In practice, storage modes of the redundant array of independent disks has many different types, such as RAID0, RAID1, RAID0+1, RAID2, RAID3, RAID4, RAID5, RAID6, RAID7, RAID10, RAID30 and RAID50 different RAID applications levels. The electronic device 9 takes the hard disks 10 as a hard disk or a logical storage drive. Of course, the RAID controller 122 also has functions for enhancing data integration, strengthening fault tolerance, and expanding capacity thereby integrating the hard disk into a plurality of redundant arrays of independent disks. The redundant arrays of independent disks can be divided into different storage modes to achieve more effective transmission efficiency and data guard function to protect the information security of the hard disks 10.

Accordingly, those skilled in the art should know that the basic operation of the second exemplary embodiment is essentially the same as the first exemplary embodiment, and should be able to infer the operation associated with the second exemplary embodiment, further descriptions are therefore omitted.

### Third Exemplary Embodiment

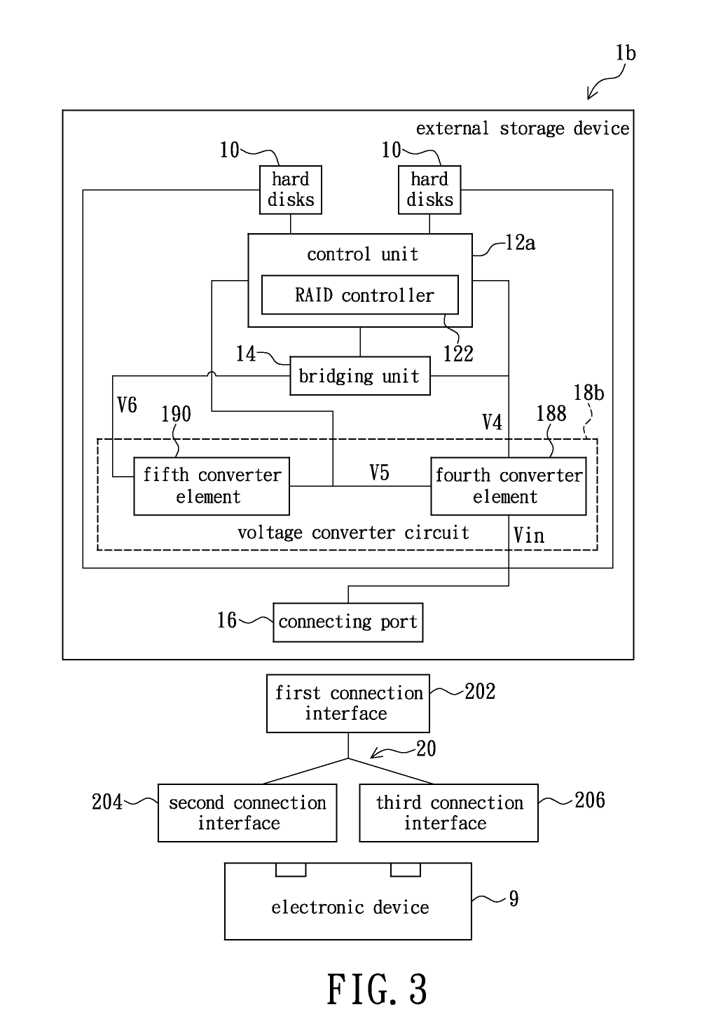

Please refer to FIG. 3. FIG. 3 is a function block diagram of an external storage device according to another exemplary embodiment of the present disclosure. The structures of the external storage device 1b (in FIG. 3) and the external storage device 1 (in FIG. 1) are similar to each other. For example, the external storage device 1b also can receive a power provided from the electronic device 9 and supply the power directly to each of the hard disks 10. However, there are still some differences between the external storage device 1b and the external storage device 1 are that: the voltage converter circuit 18b comprises a fourth converter element 188 and a fifth converter element 190, wherein the fourth converter element 188 is coupled to the connecting port 16, the fifth converter element 190, the bridging unit 14, and the control unit 12a; the fifth converter element 190 is coupled to the fourth converter element 188 and the bridging unit 14.

In detail, the fourth converter element 188 is a dual-output-port pulse wave modulator for outputting the first voltage V4 and the second voltage V5 separately. The first voltage V4 is supplied to the control unit 12a and the bridging unit 14. The second voltage V5 is supplied to the control unit 12a and the fifth converter element 190. The fifth converter element 190 is a low-dropout regulator for receiving the second voltage V5, converting the second voltage V5 into the third voltage V6. The third voltage V6 is supplied to the bridging unit 14.

For example, the connecting port 16 receives 5V voltage provided from the electronic device 9, and the 5V voltage is supplied to the hard disks 10 to drive the hard disks 10 operate normally. The fourth converter element 188 receives the power and converts it into the first voltage V4 (3.3 V) and the second voltage V5 (1.8 V). The first voltage V4 is supplied to the control unit 12a and the bridging unit 14. The second voltage V5 is supplied to the control unit 12a. In addition, the fifth converter element 190 receives the second voltage V5 and converts it into the third voltage V6 of 1.2 volts. The third voltage V6 is supplied to the bridging unit 14.

Accordingly, those skilled in the art should know that the basic operation of the third exemplary embodiment is essentially the same as the first exemplary embodiment, and should be able to infer the operation associated with the third exemplary embodiment, further descriptions are therefore omitted.

### Fourth Exemplary Embodiment

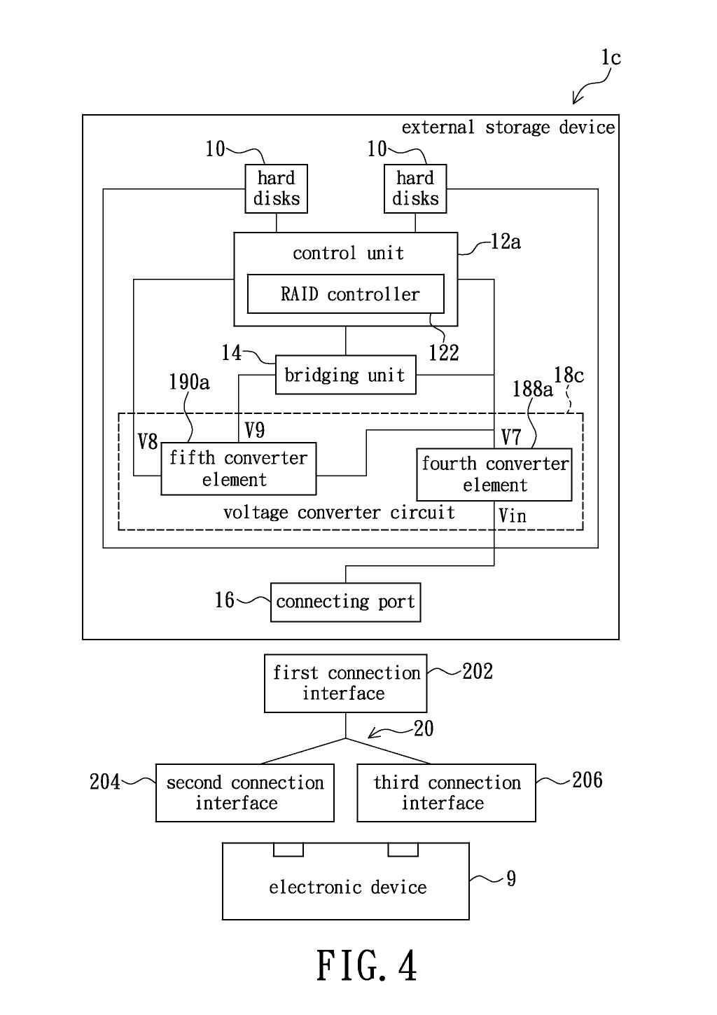

Please refer to FIG. 4. FIG. 4 is a function block diagram of an external storage device according to another exemplary embodiment of the present disclosure. The structures of the external storage device 1c (in FIG. 4) and the external storage device 1 (in FIG. 1) are similar to each other. For example, the external storage device 1c also can receive a power provided from the electronic device 9 and supply the power directly to each of the hard disks 10. However, there are still some differences between the external storage device 1c and the external storage device 1 are that: the voltage converter circuit 18c comprises a fourth converter element 188a and a fifth converter element 190a, wherein the fourth converter element 188a is coupled to the connecting port 16, the fifth converter element 190a, the bridging unit 14 and the control unit 12a; the fifth converter element 190a is coupled to the fourth converter element 188a, the control unit 12a and the bridging unit 14.

In detail, the fourth converter element 188a is a low-dropout regulator and the fifth converter element 190a is a dual-output-port pulse wave modulator. The fourth converter element 188a is coupled to the one input-port of the fifth converter element 190a, and the fifth converter element 190a receives the first voltage V7 transmitted by the fourth converter element 188a. The fifth converter element 190a converts the first voltage V7 into the second voltage V8 and the third voltage V9.

For example, the connecting port 16 receives 5V voltage provided from the electronic device 9, and the 5V voltage is supplied to the hard disks 10. The fourth converter element 188a receives the power and converts it into the first voltage V7 (3.3 V). The first voltage V7 is supplied dividedly to the fifth converter element 190a, the control unit 12a, and the bridging unit 14, wherein the fifth converter element 190a converts the first voltage V7 into the second voltage V8 (1.8 V) and the third voltage V9 (1.2 V), providing the second voltage V8 (1.8 V) to the control unit 12a, providing the third voltage V9 (1.2 V) to the bridging unit 14.

Accordingly, those skilled in the art should know that the basic operation of the fourth exemplary embodiment is essentially the same as the first exemplary embodiment, and should be able to infer the operation associated with the fourth exemplary embodiment, further descriptions are therefore omitted.

### Fifth Exemplary Embodiment

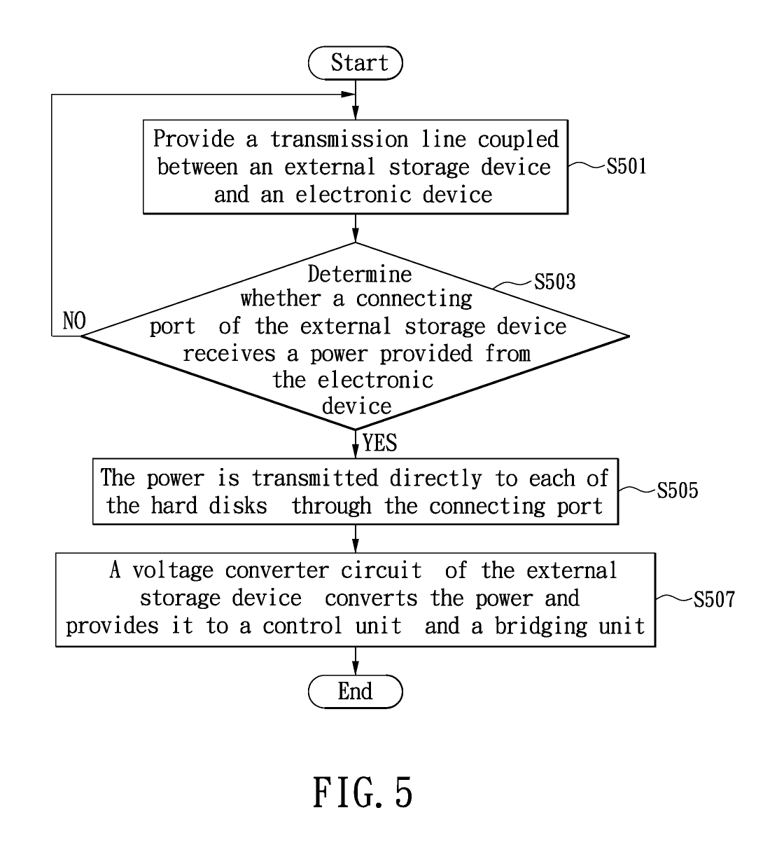

Please refer to FIG. 5 in conjunction with FIG. 1. FIG. 5 is a flow chart of a driving method of an external storage device according to another exemplary embodiment of the present disclosure. First, at step S501, an exemplary embodiment of the present disclosure provides a transmission line 20 coupled between an external storage device 1 and an electronic device 9. In practice, the transmission line 20 such as a Y-shaped transmission line, wherein two connection interfaces of the Y-shaped transmission line is coupled to the electronic device 9 and one connection interface of the Y-shaped transmission line is coupled to the external storage device 1 whereby the electronic device 9 can provide a current (more than 1400 mA) to the external storage device 1. At step S503, to determine whether a connecting port 16 of the external storage device 1 receives a power provided from the electronic device 9, if it does, the step S505 will be operated, if it doesn't, the transmission line 20 will be reinserted between the external storage device 1 and the electronic device 9, and the step S501 will be operated, again.

When the connecting port 16 of the external storage device 1 receives the power provided from the electronic device 9. At step S505, the power is transmitted directly to each of the hard disks 10 through the connecting port 16. In practice, to drive the hard disks 10 requires a higher voltage and current. Hence, the power provided from the electronic device 9 is directly supplied to drive the hard disks 10 operate normally. The power will be converted into suitable voltages through the voltage converter circuit 18 to meet the voltage requirements of the control unit 12 and the bridging unit 14.

At step S507, a voltage converter circuit 18 of the external storage device 1 converts the power and provides it to a control unit 12 and a bridging unit 14. In practice, the control unit 12 needs two different voltages, and the values of two different voltages are 3.3V voltage and 1.8V voltage separately. The bridging unit 14 also needs two different voltages, and the values of two different voltages are 3.3V voltage and 1.2V voltage. Thus, the control unit 12 can integrate the hard disks 10 into a redundant array of independent disks thereby providing different operation modes to the hard disks 10 in order to achieve more effective transmission efficiency and data guard function to protect the information security of the hard disks 10. Simultaneously, the control unit 12 controls the hard disks 10 to operate data access and data backup, and the bridging unit 14 converts a USB signal into a SATA signal.

Accordingly, the driving method of the external storage device 1 is through the electronic device 9 to receive a power, thus the external storage device 1 get the maximum efficiency by using the provided power. Of course, the driving circuit of the external storage device 1 is designed by the simplest way to promote the using of energy and the efficiency of energy-saving

In summary, the spirit of the present disclosure mainly uses the transmission line coupled between the external storage device and the electronic device, and the power provided from the electronic device is directly supplied to the hard disks through the transmission line, and then the power is converted into suitable voltages through voltage converter circuit to meet the voltage requirements of the control unit and the bridging unit whereby the control unit can control the data access of the hard disks. In addition, the control unit comprises a RAID controller thereby providing the hard disks different storage modes in order to achieve effective transmission efficiency and data guard function to protect the information security of the hard disks. By the above-mentioned mechanisms, the driving circuit design of the external storage device can be simplified and promoted the using of energy and the efficiency of energy-saving.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An external storage device, comprising:
a plurality of hard disks;
a control unit, electrically coupled to the hard disks for integrating the hard disks into a plurality of redundant arrays of inexpensive disks (RAID's);
a bridging unit, electrically coupled to the control unit;
a connecting port, electrically coupled to the hard disks; and
a voltage converter circuit, electrically coupled to the control unit, the bridging unit, and the connecting port;
wherein the external storage device receives a power provided from an electronic device through a transmission line, and the power is directly transmitted to the hard disks through the connecting port to drive the hard disks; and the voltage converter circuit converts the power and supplies the power to the control unit and the bridging unit.

2. The external storage device according to claim 1, wherein the transmission line is a Y-shaped transmission line, which comprises a first connection interface, a second connection interface and a third connection interface; the first connection interface is electrically coupled to the connecting port, and a specification of the connecting port is USB 3.0 or USB 2.0; the second connection interface and the third connection interface are electrically coupled to an output-connecting port of electronic devices, and a specification of the second connection interface is USB 3.0; and a specification of the third connection interface is USB 3.0 or USB 2.0.

3. The external storage device according to claim 1, wherein the transmission line is a single cable transmission line, comprises a first connection interface and a second connection interface; the first connection interface is electrically coupled to the connecting port, and a specification of the connecting port is USB 3.0; the second connection interface is electrically coupled to an output-connecting port of electronic devices, and a specification of the second connection interface is USB 3.0.

4. The external storage device according to claim 1, wherein the voltage converter circuit converts the power to a first voltage, a second voltage and a third voltage, and the voltage converter circuit provides the first voltage and the second voltage to the control unit, and provides a first voltage and a third voltage to the bridging unit.

5. The external storage device according to claim 1, wherein the voltage converter circuit comprises a first converter element, a second converter element and a third converter element, the first converter element is electrically coupled between the second converter element and the third converter element.

6. The external storage device according to claim 5, wherein the first converter element is a pulse wave modulator or a low-dropout regulator or a low-dropout regulator, the second converter element is a pulse wave modulator or a low-dropout regulator, and the third converter element is a pulse wave modulator or a low-dropout regulator.

7. The external storage device according to claim 1, wherein the voltage converter circuit comprises a fourth converter element and a fifth converter element, and the fourth converter element is electrically coupled to the fifth converter element.

8. The external storage device according to claim 7, wherein the fourth converter element is a dual-output-port pulse wave modulator, the fifth converter element is a low-dropout regulator, and a port of the fourth converter element is electrically coupled to the fifth converter element.

9. The external storage device according to claim 7, wherein the fourth converter element is a low-dropout regulator, the fifth converter element is a dual-output-port pulse wave modulator, and the fourth converter element is electrically coupled to an input-port of the fifth converter element.

10. The external storage device according to claim 1, wherein the bridging unit is used to convert a USB signal into a SATA signal, and transmits the SATA signal to the control unit, the control unit comprises a RAID controller for integrating the hard disks into the RAID's, and the RAID controller divides the RAID's into different storage modes to provide better transmission efficiency and to achieve data backup function, wherein each of the hard disks is a 2.5-inch hard disk.

11. A driving method of an external storage device, comprising:
providing a transmission line coupled between an external storage device and an electronic device;
determining whether a connecting port of the external storage device receives a power supplied from the electronic device;
if the connecting port of the external storage device receives the power supplied from the electronic device, the power is transmitted directly to the hard disks through the connecting port; and
by using a voltage converter circuit of the external storage device, converting the power and supplying the power to the control unit and the bridging unit.
